(19) United States
(12) Patent Application Publication
(10) Pub. No.: US 2014/0050548 A1
(43) Pub. Date: Feb. 20, 2014

(54) FASTENING CLIP

(71) Applicant: TRW Automotive Electronics & Components GmbH, Radolfzell (DE)

(72) Inventors: Hubert Loewe, Weselberg (DE); Juergen Hofmann, Eisenberg (DE); Philipp Kroell, Taufkirchen (DE); Franz Hammer, Germering (DE); Carsten Lange, Haimhausen (DE)

(73) Assignee: TRW Automotive Electronics & Components GmbH, Radolfzell (DE)

(21) Appl. No.: 13/957,705

(22) Filed: Aug. 2, 2013

(30) Foreign Application Priority Data
Aug. 17, 2012 (DE) 10 2012 016 362.2

(51) Int. Cl. F16B 5/06

(52) U.S. Cl. CPC F16B 5/0607
USPC 411/48

(57) ABSTRACT

In a fastening clip (10) for fastening a component to a carrier (24), in particular a lining part (26) of a motor vehicle to a body sheet, having an anchoring member (12) which can be inserted into an opening (22) of the carrier (24) and has latching tabs (38) which, in a latching position, can rest against an edge of the opening (22) and/or can latch thereon, and having a locking member (16) which can cooperate with the component, extends through the anchoring member (12) and is displaceable relative to these between a mounting position and a locking position in which the locking member (16) fixes the latching tabs (38) in place in the latching position, holding members (40) are provided on the anchoring member (12), with the locking member (16), upon a movement of the locking member (16) from the locking position to the mounting position, urging the holding members (40) radially outwards to a holding position, in which they engage the edge of the opening (22).

### BACKGROUND OF THE INVENTION

The present invention relates to a fastening clip for fastening a component to a carrier, in particular a lining part of a motor vehicle to a body sheet, including an anchoring member which can be inserted into an opening of the carrier and has latching tabs which, in a latching position, can rest against an edge of the opening and/or can latch thereon, and including a locking member which can cooperate with the component, extends through the anchoring member and is displaceable relative to these between a mounting position and a locking position, in which the locking member fixes the latching tabs in place in the latching position.

Two-part fastening clips include an anchoring member which can be inserted into an opening of a carrier and can be anchored therein, and a locking member which is movably supported at the anchoring member between a mounting position and a locking position. For one thing, a component, for example a lining part, may be fastened to the locking member. For another thing, the locking member fixes the anchoring member in place in the carrier by blocking the latching tabs of the anchoring member when the locking member is in a locking position, so that the latching tabs are fixed in a latching position, in which they hold the anchoring member within the opening.

For dismounting the fastening clip, the locking member first needs to be moved from this locking position to the mounting position, in which the latching tabs are released. The fastening clip typically has additional fixing members provided thereon for fixing the locking member in the locking position. To move the locking member from the locking position to the mounting position, first the resistance of these fixing members needs to be overcome. But when the locking member is moved to the mounting position, the anchoring member may be partly moved along with it due to the resistance of the fixing members, and thus the anchoring member may be pulled out of the opening. In the case of a repeated movement, this may lead to premature wear of the latching tabs, as a result of which a sufficient fixing of the fastening clip in place in the opening is no longer ensured.

### SUMMARY OF THE INVENTION

It is the object of the invention to provide a two-part fastening clip which ensures a reliable fixing of the anchoring member on a carrier, even in the event of a movement of the locking member from the locking position to the mounting position.

To achieve the object, in a fastening clip of the type initially mentioned, holding members are provided on the anchoring member, with the locking member, upon a movement of the locking member from the locking position to the mounting position, urging the holding arms radially outwards to a holding position, in which they engage the edge of the opening. The holding members provide an additional holding force during the process of displacing the locking member from the locking position to the mounting position, in order to fix the anchoring member in place in the opening, so that the anchoring member is safely held on the carrier. A damage to the anchoring member or to the latching tabs of the anchoring member is reliably excluded, so that a long-term, reliable fixing of the anchoring member on the carrier and thus a reliable functioning of the fastening clip is ensured even in the case of repeated operation.

In order to urge the holding members radially outwards to the holding position, the locking member may, for example, include radially protruding projections. The projections protrude over the radial inside of the holding members as viewed in the longitudinal direction of the fastening clip, so that when the locking member is displaced from the locking position to the mounting position, the projections contact the radial inside of the holding members and can urge them radially outward upon a further displacement.

To fix the locking member in the locking position, the anchoring member and the locking member, for example, have cooperating latching members provided thereon which hold the locking member in the locking position and/or in the mounting position, the latching members of the locking member being more particularly adjacent to the projections. The latching members may, for example, be formed by a radial constriction in front of or behind the projections. Since the latching members and the projections are adjacent to each other, the holding members are immediately urged radially outward when the locking member is displaced, so that a correspondingly greater holding force for the anchoring member is provided on the carrier at a very early point in time.

The latching members of the anchoring member may also be provided on the holding members. Upon a movement of the locking member to the mounting position, the latching members of the anchoring member are urged radially outward to release the locking member, so that the holding members are compulsorily urged radially outward along with them.

The latching tabs may, for example, include latching slopes facing radially outwards, so that the latching tabs can reliably rest against the edge of the opening and can in this way fix the anchoring member in place, even in the case of openings of different sizes or carriers of different thicknesses.

For sealing the opening in the component, the anchoring member may have a radially surrounding sealing member provided thereon which rests against the carrier by a first sealing lip and seals the opening. The sealing member may also include a second radially surrounding sealing lip which, in the locking position of the locking member, rests against the locking member and/or against the component in a circular manner in the circumferential direction. This second sealing lip allows an additional sealing action, so that water is prevented from penetrating through openings on the locking member into the intermediate space between the component and the carrier. Since the locking member is inserted into the anchoring member from the mounting position to the locking position, the locking member or the component is moved against the second sealing lip during this movement.

To fasten the component to the locking member, a seat for the component is preferably provided on the locking member, the seat having at least one circular flange. The component may have a recess or opening for slipping it onto this flange, with a circular flange offering the advantage that the component is mounted for rotation on the flange and can thus be swiveled about the longitudinal axis of the fastening clip as desired. It is therefore not required to align the fastening clip during assembly.

This flange may have at least one spring member provided thereon which rests against the component and fixes it in place on the locking member. The spring member urges the component against another member of the seat, for example, and the component is thus clamped between the spring member and the other member. Moreover, in this way the component may be held free of clearance, as a result of which a generation of noise due to rattling of the component at the locking member can be prevented. The spring member may be formed more particularly by a circumferentially surrounding spring lip.

To achieve a centric centering and a uniform distribution of the holding force on the edge of the opening, the latching tabs and/or the holding members are preferably arranged on the anchoring member opposite each other in pairs in the circumferential direction.

The holding members may be arranged on the anchoring member separately from the latching tabs and may in particular be arranged offset by 90 degrees in relation thereto in the circumferential direction, so that the holding force is evenly distributed to the edge of the opening in the circumferential direction.

An optional cover cap may be provided which can be placed on the locking member to fix it in place in the anchoring member, so that any inadvertent removal of the locking member or losing the locking member prior to assembly can be prevented.

### BRIEF DESCRIPTION OF THE DRAWINGS

Further advantages and features will be apparent from the description below in conjunction with the accompanying drawings, in which:

FIG. 1 shows an exploded view of a fastening clip according to the invention;

FIG. 2 shows the fastening clip of FIG. 1 in the installed state;

FIGS. 3a and 3b show perspective views of the anchoring member of the fastening clip of FIG. 1;

FIGS. 4a and 4b show perspective views of the locking member of the fastening clip of FIG. 1;

FIGS. 5a and 5b show sectional views of the fastening clip of FIG. 1 in a mounting position of the locking member; and

FIGS. 6a and 6b show sectional views of the fastening clip of FIG. 1 in a locking position of the locking member.

### DESCRIPTION OF EXEMPLARY EMBODIMENT

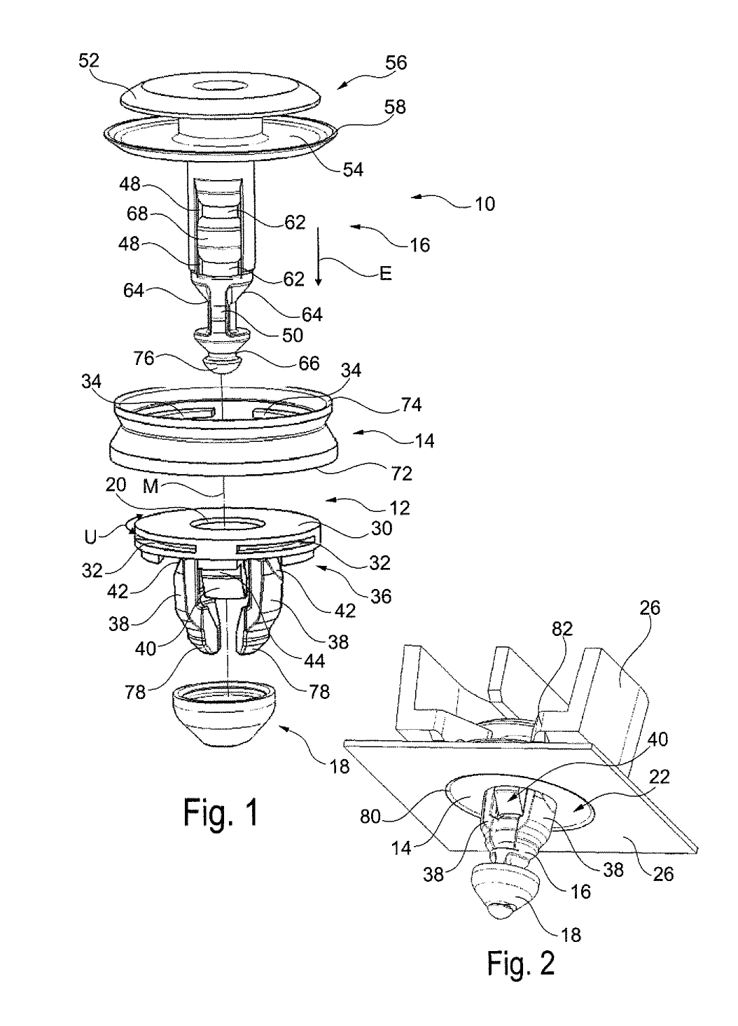

FIG. 1 shows a fastening clip 10 including an anchoring member 12 which has a sealing member 14 provided thereon, a locking member 16 and a cover cap 18.

As can be seen in FIG. 2, a component such as, e.g., a lining part 26, may be fastened to the locking member 16, the component being adapted to be mounted to a carrier 24 by means of the fastening clip 10. To this end, the anchoring member 12 may be inserted into an opening 22 of a carrier 24 and be fixed in place therein, and includes a seat 20 for insertion of the locking member 16 therein.

In addition to fastening the component, the locking member 16 has the function of fixing the anchoring member 12 in place in the carrier 24 in that latching tabs 38 that are provided on the anchoring member 12 are fixed in a latching position, as will be discussed below.

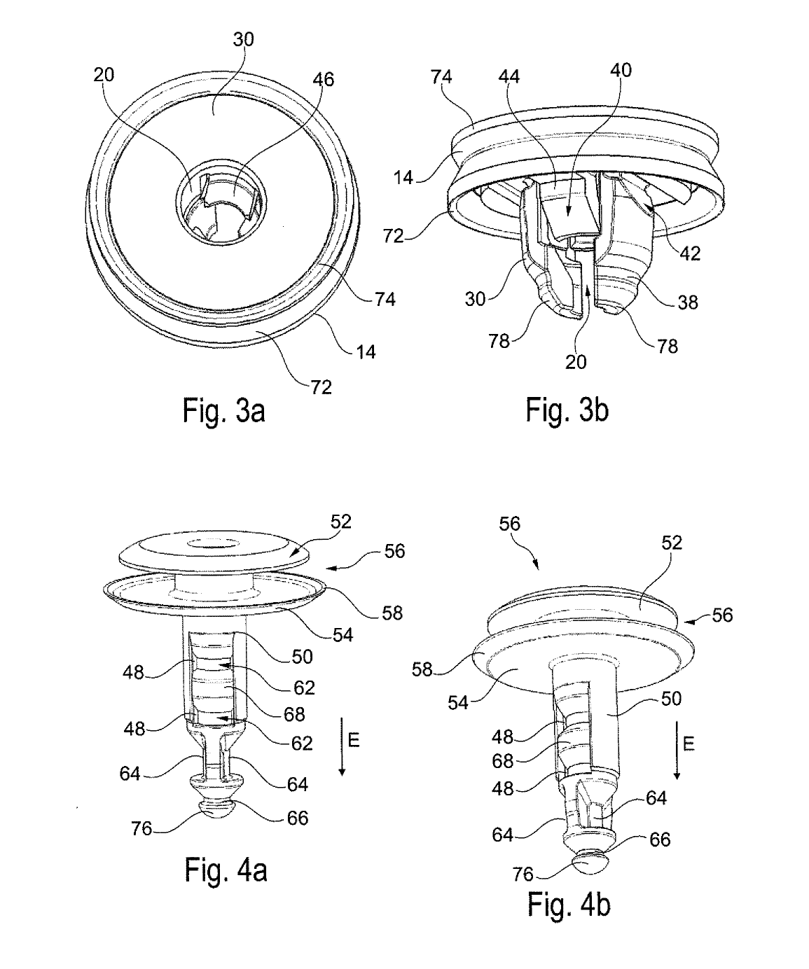

As can be seen in FIGS. 3a and 3b, the anchoring member 12 has a cylindrical base body 30 in which the seat 20 is provided in the longitudinal direction of the cylinder. The sealing member 14 is fastened to the base body 30 in a manner surrounding the base body 30 in the circumferential direction U, with holding slots 32 being provided on the base body 30 which extend in the circumferential direction and which can be engaged by corresponding projections 34 of the sealing member 14 (see FIG. 1).

Provided on the lower side 36 of the anchoring member 12 are a pair of latching tabs 38 that are arranged radially opposite each other in relation to the center axis M of the fastening clip 10, and a pair of holding members 40 which are offset by 90 degrees in the circumferential direction U in relation to the latching tabs and which are also arranged around the seat 20 opposite each other in pairs.

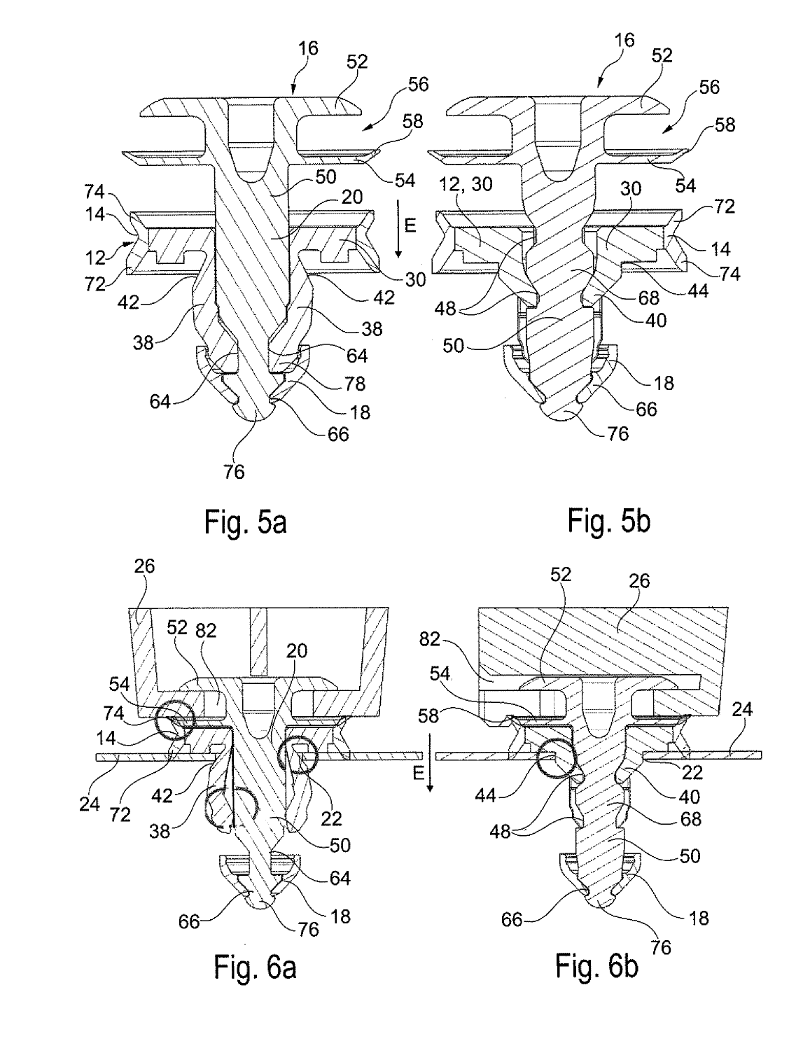

As can be seen in particular in FIG. 3b, the latching tabs 38 include latching slopes 42 facing radially outwards and which extend radially outwards in an insertion direction E. In the non-installed condition, the outer surfaces 44 of the holding members 40 extend parallel to the insertion direction E (see also FIG. 5b).

As can be seen in FIG. 3a, latching members 46 are provided in the seat 20 which are directed radially inwards and which are adapted to cooperate with corresponding latching members 48 of the locking member 16 (see FIGS. 4a and 4b).

As can be seen in particular in FIG. 5b, the latching members 46 are arranged on the holding members 40 here. But it is possible that they are arranged on the base body 30 of the anchoring member 12 separately from the holding members 40.

The locking member 16 includes a pin 50 extending in the insertion direction E and adapted to be inserted into the seat 20 of the anchoring member 12, and a seat 56 for the component, the seat 56 being formed of two flanges 52, 54.

Both flanges 52, 54 are arranged parallel to each other and perpendicular to the insertion direction E and have a circular configuration. The first flange 52, which is the rear flange viewed in the insertion direction E, has a flat lower side. The second flange 54 has a spring lip 58 provided thereon surrounding it in the circumferential direction U and projecting toward the first flange 52.

Provided on the pin 50 are two constrictions 62 which are spaced apart from each other in the insertion direction E and each of which constitutes a latching member 48 that is adapted to cooperate with the latching members 46 of the anchoring member 12. A projection 68 is provided between the latching members 48 that is continuous in the circumferential direction U and projects beyond the latching members 48 in the radial direction.

Furthermore, recesses 64 are provided in front of the latching members 48 in the insertion direction E, the latching tabs 38 of the anchoring member 12 being adapted to resiliently engage into the recesses 64, and a surrounding groove 66 is provided at the end 76 which is the front end in the insertion direction E, the cover cap 18 being adapted to be mounted to the groove 66.

FIGS. 5a and 5b show the fastening clip 10 in a pre-assembly condition, in which the locking member 16 is inserted in the seat 20 of the anchoring member 12 and is in a mounting position, in which the latching tabs 38 are freely movable between a release position and a holding position (see FIG. 6a).

The sectional views 5a and 5b are each arranged offset by 90 degrees with respect to the center axis M, so that FIG. 5a shows a view of a section taken through the latching tabs 38 and FIG. 5b shows a view of a section taken through the holding members 40 of the anchoring member 12.

In the mounting position, the pin 50 of the locking member 16 extends through the entire seat 20 and protrudes out of the anchoring member 12 on the lower side 36. In the mounting position, the latching tabs 38 are situated in the recesses 64 of the locking member 16. The cover cap 18 is slid onto the end 76 of the pin and held at the groove 66.

The cover cap 18 has a conical configuration and, in the mounting position of the locking member 16, encloses the front ends 78 of the latching tabs 38 in the circumferential direction U, so that the latter cannot be bent open radially outward. In addition, the cover cap 18 covers the latching tabs 38 counter to the insertion direction E. This protects the latching tabs 38, so that the latching tabs 38 are reliably prevented from getting inadvertently caught on the edge 80 of the opening (see FIGS. 6a and 6b) when the anchoring member 12 is mounted in the carrier 24.

As is apparent from FIG. 5b, the latching members 46 of the anchoring member 12 are latched in the front latching members 48—with respect to the insertion direction E—of the locking member 16, so that the locking member 16 is held in the mounting position.

For mounting the fastening clip 10, the anchoring member 12 is inserted into an opening 22 of the carrier 24 (FIGS. 6a and 6b). Then the lining part 26 is mounted to the locking member 16 by sliding the lining part 26 by a recess 82 onto the flanges 52, 54 in the radial direction, so that the lining part is clamped between the flanges 52, 54. The lining part 26 is urged against the first flange 52 by the spring lip 58 and is in this way held on the locking member 16 free of play. The spring lip 58 here accomplishes a tolerance compensation between the lining part 26 and the locking member 16.

Subsequently, the locking member 16 is displaced in the insertion direction E until the latching members 46 of the anchoring member 12 latch onto the rear latching members 48—with respect to the insertion direction E—of the locking member 16 (FIG. 6b).

As is apparent from FIG. 6a, in this locking position the latching tabs 38 are moved radially outwards so that they engage the edge 80 of the opening 22 of the carrier 24 to fix the anchoring member 12 or, in other words, the fastening clip 10, in place in the opening 22.

The latching tabs 38 may rest against, or latch onto, the edge of the opening already prior to insertion of the locking member 16. But it is also conceivable that the latching tabs do not latch onto the edge 80 until when the locking member 16 is inserted.

As can be seen in FIGS. 6a and 6b, the sealing member 14 has a first sealing lip 72 which rests against the carrier 24 in a circular manner in the circumferential direction U and in this way completely seals the opening 22. Furthermore, provision is made for a second sealing lip 74 which, in the locking position, rests against the flange 54 and/or against the lining part 26 and seals the anchoring member 12 in relation to the locking member 16 and to the lining part 26. The sealing Up 74 further ensures that any water that may come from the tip of the clip along the pin 50 through the seat 20 and reaches the flange 54 is stopped there since the sealing lip 74 reliably seals at the flange 54.

For dismounting the lining part 26 or the fastening clip 10, the locking member 16 is pulled from the locking position (FIGS. 6a and 6b) to the mounting position (FIGS. 5a and 5b) contrary to the insertion direction E, as a result of which the latching tabs 38 are no longer fixed in the latching position by the locking member 16 and/or can spring back to a release position, so that the fastening clip 10 can be removed from the opening 22.

A problem involved here is that the holding force of the anchoring member 12 as provided by the latching tabs 38 will decrease during this process of displacing the locking member 16 from the locking position to the mounting position, since the latching tabs 38 may spring back radially inwards as early as during this displacement process. In addition, the locking member 16 is however held on the anchoring member 12 by the cooperating latching members 46, 48. This may lead to the anchoring member 12 being able to be pulled out of the opening 22 together with the locking member 16 even before the locking member 16 reaches the mounting position, as a result of which the latching tabs 38 may be worn or damaged, in particular when this process is repeated several times.

In order to prevent this, a projection 68 is provided between the latching members 48 in which the latching members 46 of the anchoring member latch in the mounting position (FIG. 5b) and in the locking position (FIG. 6b), the projection 68 urging the holding members 40 radially outward to a holding position during the displacement of the locking member from the locking position to the mounting position, the holding position being indicated by a dashed line in each of FIGS. 6a and 6b.

In this holding position, the holding members 40 engage the edge of the opening 22, so that an increased holding force is provided by them for the anchoring member 12 in the opening 22 and a withdrawal of the anchoring member 12 from the opening 22 is reliably prevented.

When the locking member 16 has reached the mounting position, the latching members 46 can spring back into the recesses 64, so that the holding members 40 can also be moved back to their initial position, as a result of which a smaller holding force is provided and a dismounting of the anchoring member 12 is possible.

As can be seen in FIGS. 4a and 4b and in 5b and 6b, the projections 68 are directly adjacent to the latching members 48 of the locking member 16, so that even a slight movement of the locking member 16 in relation to the anchoring member 12 results in an immediate movement of the latching members 46 or the holding members 40 radially outward and, thus, in a fixing of the anchoring member in place in the opening 22.

But the projections 68 may also be arranged at any other place of the locking member 16 as desired. It should only be made sure that the holding members 40 are urged radially outward against the edge 80 of the opening 22 by the projections 68. Embodiments in which the holding members 40 can be moved radially outward by other devices are also conceivable. In particular, the holding members 40 need not be arranged on the latching members 46 of the anchoring member 12.

As can be seen in FIGS. 5a and 5b, the latching tabs 38 include latching slopes 42 facing radially outward, which allow the fastening clip 10 to be mounted in openings 22 of different sizes or in carriers 24 of different thicknesses. In addition, the latching slopes 42 facilitate the removal of the anchoring member 12 from the opening 22 since, during a movement contrary to the insertion direction E, the latching tabs 38 can be urged radially inward by the edge 80 of the opening 22.

The holding members 40 and the latching tabs 38 are arranged opposite each other in pairs here, so that the anchoring member 12 is centered in the middle in the opening 22. But the latching tabs 38 and/or the holding members 40 may also be positioned differently. In particular, a plurality of latching tabs 38 and/or a plurality of holding members 40 may also be provided.

1. A fastening clip (10) for fastening a component to a carrier (24), in particular a lining part (26) of a motor vehicle to a body sheet, comprising an anchoring member (12) which can be inserted into an opening (22) of the carrier (24) and has latching tabs (38) which, in a latching position, can rest against an edge of the opening (22) and/or can latch thereon, and comprising a locking member (16) which can cooperate with the component, extends through the anchoring member (12) and is displaceable relative to these between a mounting position and a locking position, in which the locking member (16) fixes the latching tabs (38) in place in the latching position, wherein holding members (40) are provided on the anchoring member (12), with the locking member (16), upon a movement of the locking member (16) from the locking position to the mounting position, urging the holding members (40) radially outwards to a holding position, in which they engage the edge of the opening (22).

2. The fastening clip according to claim 1, wherein the locking member (16) includes radially protruding projections (68) against which the holding members (40) rest upon a movement of the locking member (16) from the locking position to the mounting position and which urge the holding members (40) radially outwards.

3. The fastening clip according to claim 1, wherein the anchoring member (12) and the locking member (16) have cooperating latching members (46, 48) provided thereon which hold the locking member (16) in the locking position and/or in the mounting position, the latching members (48) of the locking member (16) being more particularly adjacent to the projections (68).

4. The fastening clip according to claim 3, wherein the latching members (46) of the anchoring member (12) are provided on the holding members (40).

5. The fastening clip according to claim 1, wherein the latching tabs (38) include latching slopes (42) facing radially outwards.

6. The fastening clip according to claim 1, wherein the anchoring member (12) has a radially surrounding sealing member (14) provided thereon which rests against the carrier (24) by a first sealing lip (72) and seals the opening (22).

7. The fastening clip according to claim 6, wherein the sealing member (14) includes a second radially surrounding sealing lip (74) which, in the locking position of the locking member (16), rests against the locking member (16) and/or against the component in a circular manner in the circumferential direction (U).

8. The fastening clip according to claim 1, wherein a seat (56) for the component is provided on the locking member (16), the seat having at least one circular flange (52, 54).

9. The fastening clip according to claim 8, wherein the flange (52, 54) has at least one spring member provided thereon, in particular a spring lip (58) surrounding it in the circumferential direction (U), the spring member resting against the component and fixing it in place on the locking member (16).

10. The fastening clip according to claim 1, wherein the latching tabs (38) and/or the holding members (40) are arranged opposite each other in pairs in the circumferential direction (U).

11. The fastening clip according to claim 1, wherein the holding members (40) are arranged on the anchoring member (12) separately from the latching tabs (38) and in particular are arranged offset by 90 degrees in relation thereto in the circumferential direction (U).

12. The fastening clip according to claim 1, wherein a cover cap (18) is provided which can be placed on the locking member (16) and fixes it in place in the anchoring member (12).
